(19) United States
(12) Patent Application Publication
(10) Pub. No.: US 2014/0147269 A1
(43) Pub. Date: May 29, 2014

(54) AIRCRAFT NACELLE INCORPORATING AN IMPROVED CONNECTION BETWEEN AN AIR INTAKE AND A POWERPLANT

(71) Applicant: Airbus Operations (SAS), Toulouse (FR)

(72) Inventors: Alain Porte, Colomiers (FR); Martial Marro, Plaisance Du Touch (FR)

(21) Appl. No.: 14/085,905

(22) Filed: Nov. 21, 2013

(30) Foreign Application Priority Data
Nov. 23, 2012 (FR) 20120061167

(51) Int. Cl. F02C 7/04

(52) U.S. Cl. CPC F02C 7/04
USPC 415/213.1

(57) ABSTRACT

An aircraft nacelle comprising two ducts, a first duct secured to an air intake and a second duct secured to a powerplant. The ducts are arranged coaxially in a longitudinal direction, in contact with one another at a junction plane and joined together by a connection which comprises a plurality of through holes oriented in the longitudinal direction and connecting elements housed in the through holes. Each connecting element comprises a shank with, at each end, lands allowing the ducts to be joined together. At least one through hole of at least one of the two ducts has an oblong section with the largest dimension oriented to allow relative rotation of the two ducts about an axis in the longitudinal direction.

### CROSS-REFERENCES TO RELATED APPLICATIONS

This application claims the benefit of the French patent application No. 20120061167 filed on Nov. 23, 2012, the entire disclosures of which are incorporated herein by way of reference.

### BACKGROUND OF THE INVENTION

The present invention relates to an aircraft nacelle incorporating an improved connection between an air intake and a powerplant.

An aircraft propulsion unit comprises a nacelle containing, arranged substantially concentrically, a powerplant connected by a pylon to the rest of the aircraft.

As illustrated in FIG. 1, the nacelle comprises at the front an air intake 10 that channels a flow of air towards the powerplant 12, a first part of the incoming air flow, referred to as the primary flow, passing through the powerplant to participate in combustion, the second part of the air flow, referred to as the secondary flow, being driven by a fan and flowing along an annular duct delimited by the interior wall of the nacelle and the exterior wall of the powerplant.

In the remainder of the description, the longitudinal direction corresponds to the direction of the axis of pivoting of the powerplant fan. A radial direction corresponds to a direction perpendicular to the longitudinal direction, crossing the axis of pivoting of the powerplant fan. A tangential direction, in a point, corresponds to a direction perpendicular to the longitudinal direction and perpendicular to the radial direction in this point.

The air intake 10 comprises a lip 11 of which the surface in contact with the aerodynamic flows is extended inside the nacelle by an inner duct 16 of substantially circular sections and outside the nacelle by an exterior wall 18 of substantially circular sections. The powerplant comprises a duct 19 that can be positioned in the continuation of the inner duct 16.

The air intake 10 is connected to the powerplant 12 by a connection illustrated in detail in FIGS. 2, 3A and 4A. The connection comprises, at the powerplant, a first annular ring flange 20 secured to a second annular ring flange 22 of a panel delimiting the duct 16 or an intercalated component 24, referred to as a flange, connected to the panel delimiting the duct 16, as illustrated in FIG. 2. The two ring flanges 20 and 22 are pressed firmly together at a junction plane 38 substantially perpendicular to the longitudinal direction, and held in this state by connecting elements 28, for example screw fasteners or rivets, which pass through the ring flanges 20, 22 and run parallel to the longitudinal direction.

In a first embodiment illustrated in FIG. 3A, the screw fasteners or rivets 28 comprise a shank 30 the diameter of which can be matched to that of the through holes made in the annular ring flanges 20 and 22.

According to a second embodiment illustrated in FIG. 3B, the diameter of the through holes made in the annular ring flanges 20 and 22 may be slightly greater than that of the shank 30 of the screw fasteners or rivets 28. This clearance of the order of 1 mm between the through holes and the screw fasteners or rivets 28 allows relative movement between the two elements that are joined together.

In both instances, the through holes are cylindrical.

The screw fasteners or rivets 28 are dimensioned to alleviate the potential risks of incidents, such as the breakage of a fan blade for example.

In such a situation, the duct of the powerplant may deform over its entire periphery. With these deformations, the through holes in the annular ring flange of the powerplant are no longer aligned with those of the air intake. Under such circumstances, the screw fasteners or rivets 28 are subjected notably to relatively high shear stresses, which are markedly higher than the stresses they are subjected to in normal operation. Even though the second embodiment allows relative movement between the two parts joined together because of the clearance present around the screw fasteners or rivets 28, this clearance is markedly smaller than the relative movement experienced by the two parts joined together in the event of an incident such as a blade breakage. In the case of the second embodiment with clearance, it is found that the shear stresses are at least equal to those present in the first embodiment, if not higher.

In order to be able to withstand such stresses, the connection between the air intake and the powerplant comprises a given number of screw fasteners or rivets 28 of a given diameter.

Given the strength of a screw fastener or rivet 28 in a setup according to the embodiments illustrated in FIGS. 3A and 3B, that leads to the provision, for connection purposes, of a great many screw fasteners or rivets 28 and/or of screw fasteners or rivets 28 of large diameter, leading to a greater onboard mass and therefore to a higher energy consumption for the aircraft.

In order to limit the spread of deformation of the annular ring flange 20 of the powerplant to the ring flange 22 of the air intake, it is possible to provide a filter at the connecting elements 26. For each connecting element, this filter comprises at least one deformable sheath 30 slipped over the shank 28 of the connecting element 26, as illustrated in FIGS. 3A and 3B. This deformable sheath 30 may be intercalated between the annular ring flange 20 connected to the powerplant and a nut 32 of the connecting element 26. This deformable sheath 30 has an inside diameter matched to that of the shank 28 and in its central part has a relatively small thickness so that it can deform, notably in buckling. This arrangement makes it possible to increase the amount of energy absorbed by deformation of the connecting element. It also makes it possible to limit the spread of deformation in the axial direction.

In order to reduce the onboard mass, document FR-2 970 753 proposes a special geometry for the through holes 34 and 36 provided respectively in the ring flanges 20, 22 for the passage of the connecting elements 26, as illustrated in FIGS. 4A and 4B.

For a given connecting element, according to that document, the through holes 34 and 36 each comprise at least one section that is of reduced size and matched to the shank 28 of the connecting element 26 and one section with a significant clearance at the junction plane 38 so that the said shank 28 experiences only very small shear loadings at the junction plane in the event of relative deformation of the ducts.

As illustrated in FIG. 4A, the through holes 34 and 36 have circular sections in planes perpendicular to the axis of the shank. As illustrated in FIG. 4B, the through holes have a shape that widens towards the junction plane 38.

Thanks to the geometric shapes of the through holes, the connecting elements have greater strength. This makes it possible to limit the number and/or the oversizing of the connecting elements, and therefore the onboard mass, by substantially reducing the shear stresses to which the said connecting elements are subjected.

As with the variants illustrated in FIGS. 3A and 3B, it is possible to add a deformable sheath 30 in order to limit the spread of deformation in the axial direction (perpendicular to the longitudinal direction of the nacelle).

The present invention seeks to improve the connection proposed in document FR-2 970 753.

### SUMMARY OF THE INVENTION

Thus the invention proposes an aircraft nacelle comprising two ducts, a first duct secured to an air intake and a second duct secured to a powerplant, the said ducts being arranged coaxially in a longitudinal direction, in contact with one another at a junction plane and joined together by a connection which comprises a plurality of through holes oriented in the longitudinal direction and connecting elements housed in the through holes, each comprising a shank with, at each end, lands allowing the said ducts to be joined together, characterized in that at least one through hole of at least one of the two ducts has an oblong section with the largest dimension oriented to allow relative rotation of the two ducts about an axis in the longitudinal direction.

According to the invention, the connection between the air intake and the powerplant makes it possible to limit the spread of circumferential deformation over at least part of the circumference of the ducts, the said circumferential deformation resulting from torsional stresses in the longitudinal direction between the two ducts.

### BRIEF DESCRIPTION OF THE DRAWINGS

Further features and advantages will emerge from the description which follows of the invention, which description is given purely by way of example, with reference to the attached drawings in which:

FIG. 1 is a schematic section on a radial plane of part of the front of an aircraft nacelle,

FIG. 2 is a perspective view illustrating part of a connection between an engine and an air intake of an aircraft nacelle according to the prior art,

FIG. 3A is a cross section illustrating a connecting element connecting an engine and an air intake of an aircraft nacelle according to a first embodiment of the prior art,

FIG. 3B is a cross section illustrating a connecting element connecting an engine and an air intake of an aircraft nacelle according to a second embodiment of the prior art,

FIG. 4A is a cross section illustrating a connecting element connecting an engine and an air intake of an aircraft nacelle according to a third embodiment of the prior art,

FIG. 4B is a perspective view from the junction plane of a through hole according to the third embodiment illustrated in FIG. 4A,

FIG. 5A is a cross section illustrating a connecting element connecting an engine and an air intake of an aircraft nacelle according to a first variant of the invention,

FIG. 5B is a perspective view from the junction plane of several through holes some of which are in accordance with the variant of the invention illustrated in FIG. 5A,

FIG. 6A is a cross section on a plane perpendicular to the longitudinal direction illustrating a connecting element in a through hole according to the variant illustrated in FIG. 5A,

FIG. 6B is a cross section on a plane perpendicular to the longitudinal direction, illustrating a connecting element in a through hole according to another variant of the invention,

FIG. 7 is a section on AA of FIG. 6B,

FIGS. 8A to 8C are sections on a plane perpendicular to the longitudinal direction, illustrating a connecting element in a through hole according to other variants of the invention,

FIG. 9 is a section on IX-IX of FIG. 6A.

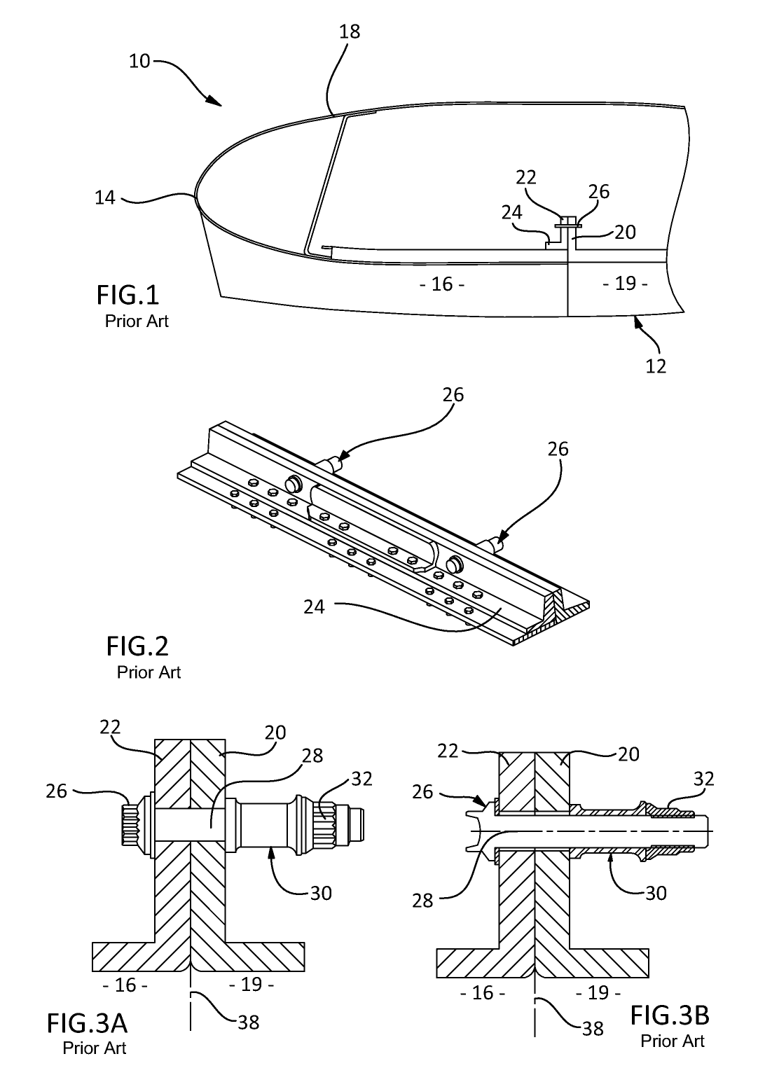

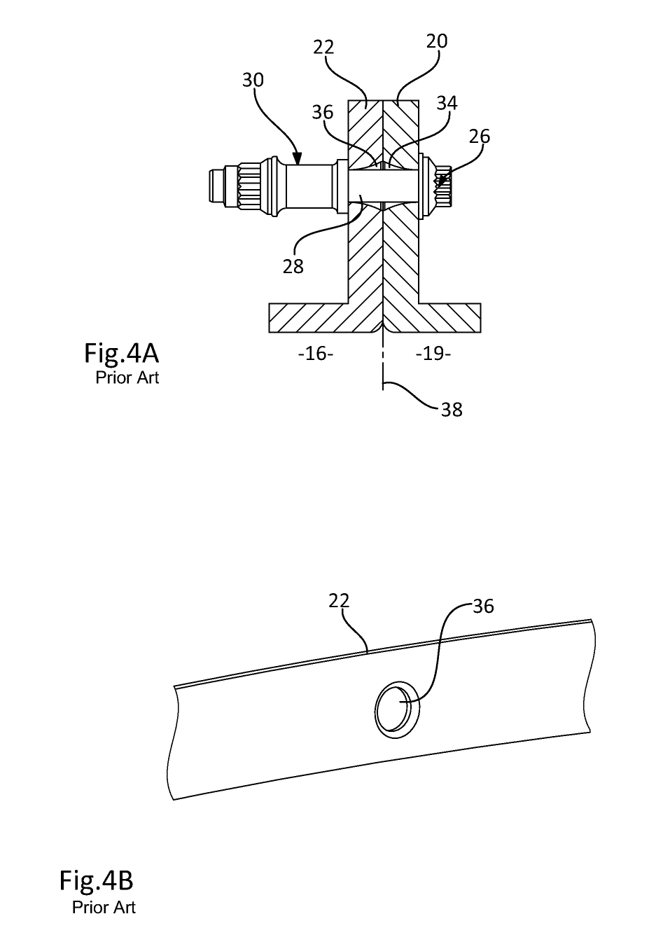

### DETAILED DESCRIPTION OF THE PREFERRED EMBODIMENTS

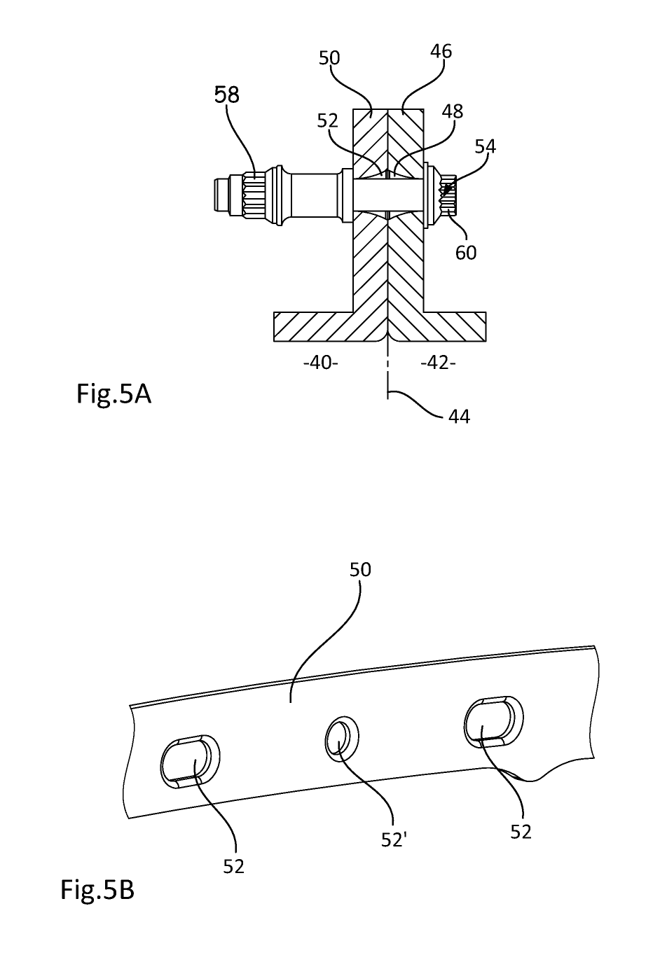

FIG. 5A depicts, in cross section, part of a junction zone at the junction between a duct 40 of an air intake and a duct 42 of a powerplant of an aircraft nacelle. The ducts 40 and 42 are arranged in the continuation of one another coaxially in the longitudinal direction and are in contact with one another at a junction plane 44 approximately perpendicular to the longitudinal direction.

According to one embodiment, the duct 42 of the powerplant comprises an annular ring flange 46 extending in a plane substantially perpendicular to the longitudinal direction and comprising a plurality of through holes 48 oriented in the longitudinal direction. The duct 40 of the air intake comprises an annular ring flange 50 extending in a plane substantially perpendicular to the longitudinal axis of the nacelle, pressed firmly against the annular ring flange 46 of the powerplant at the junction plane 44, and comprising a plurality of through holes 52 oriented in the longitudinal direction and arranged in the continuation of the through holes 48 of the powerplant. The through holes 48 and 52 are distributed about the circumference of the annular ring flanges 46 and 50.

In addition to this, the connection between the two ducts 40 and 42 comprises connecting elements 54 housed in the through holes 48 and 52.

Depending on the circumstances, an annular ring flange may be produced as a single piece with the powerplant or the air intake, or may take the form of a flange connected to the powerplant or the air intake.

Each connecting element 54 comprises a shank 56 in the form of a cylinder with, at a first end, a first land 58 that can be pressed firmly against the free face of one of the ring flanges, in this instance the annular ring flange 50 of the air intake, and, at the other end, a second land 60 which can be pressed firmly against the free face of the other ring flange, in this instance the annular ring flange 46 of the powerplant. The shanks 56 have axes parallel to the longitudinal direction.

According to one embodiment, a connecting element 54 may take the form of a screw fastener having, on the one hand, a bolt comprising a shank with a head (corresponding to the first land 58) at a first end and a screw thread at the other end and, on the other hand, a nut (corresponding to the second land 60) screwed onto the end of the bolt.

As a variant, the connecting element may take the form of a rivet with a shank comprising, at a first end, a head that forms a first land 58 and the other end of which is deformed to form the second land 60.

The shank 56 of the connecting element has a diameter D that is determined according to the stresses experienced, essentially tensile stresses.

In the remainder of the description, the profile means the limits of a through hole in a plane containing the longitudinal direction.

A section corresponds to the limit of a through hole in a plane perpendicular to the longitudinal direction.

A radial direction is a direction perpendicular to the longitudinal direction, crossing the axis of pivoting of the powerplant fan.

Advantageously, the through holes 48 and 52 are not cylindrical but have sections that widen towards the junction plane 44.

According to one embodiment, each through hole 48 or 52 has at least one section matched to the shank 56 of the connecting element near the corresponding land 58 or 60, and a section with a significant clearance at the junction plane 44.

When a section is said to be matched, that means that the diameter of the through hole 48 or 52 is equal to the diameter of the shank 56 or comprised within a tolerance band of +/−1 mm.

The shank 56 is perfectly guided at the lands 58 and 60 and can deform at the junction plane 44.

This arrangement allows the connecting elements 54 to absorb, through plastic and/or elastic deformation, some of the energy produced if the blade impacts against the duct of the powerplant. In addition, the shank 56 is subjected to lower shear stresses than in the prior art, which means that it is possible to reduce the number and/or diameter of the connecting elements 54.

According to a first embodiment, for each ring flange 46, 50, the through hole 48, 52 comprises a seating with a section matched to that of the shank 56 over a distance extending from the free surface in contact with one of the lands 58 and 60 and which is less than one third of the total length of the through hole 48, 52. Over the remainder of the thickness of the ring flange 46, 50, the through hole 48 and 52 has a diameter much greater than that of the shank 56. Much greater means that the diameter of the through hole 48, 52 exceeds a value of D+10%, D being the diameter of the shank 56.

As indicated in document FR-2 970 753, the profile of the through holes 48 and 52 has a first radius of curvature at the junction plane 44.

Advantageously, the first radius of curvature is such that its tangent at the lands 50 or 52 is perpendicular to the axis of the shank 56.

In addition to having a radius of curvature at the junction plane, the profile of the through holes 48 and 52 has a second radius of curvature at the smallest cross section.

The profile of the through holes 48 and 52 is not detailed further because it may be in accordance with that of one of the variants described in document FR-2 970 753.

In order to limit the spread of deformation in the longitudinal direction, at least one deformable sheath may be slipped over the shank 56 and interposed between one of the ring flanges and one of the lands. This deformable sheath has an inside diameter matched to that of the shank 56 and in the central part has a relatively small thickness so that it can curve with the shank as the latter deforms.

According to one important aspect of the invention, at least one through hole 52 of one of the two ring flanges has an oblong section the largest dimension of which is oriented in such a way as to allow relative rotation of the two ducts about an axis in the longitudinal direction.

An oblong section means that the through hole 52 has a non-circular section with a dimension in a first direction that is larger than another dimension in another direction.

In order to allow relative rotation of the two ducts about an axis in the longitudinal direction, the larger direction of the oblong section is preferentially oriented in an approximately tangential direction.

Advantageously, the smallest dimension of the oblong section is oriented in an approximately radial direction.

In case of an important deformation having both a radial component and a tangential component, the oblong section of the holes allows the absorption of the energy of each of these components at different time. In a first time, indeed, the energy of the radial deformation is absorbed thanks to the contact between the shank 56 and the border of the hole, in the smallest dimension of the oblong section of the hole. During this first time, the shank 56 moves in the hole in the tangential direction, without important absorption of the energy of the tangential deformation. In a second time, after the absorption of at least a part of the energy of the radial deformation, the shank 56 makes contact with the border of the hole, in the largest dimension of the oblong section of the hole. The energy of the tangential deformation is then absorbed thanks to this contact. The absorption of the energy of the deformation is then distributed in time, which allows a better resistance of the connection.

According to a first variant, all the through holes 52 of one of the ring flanges have oblong sections.

Advantageously, as illustrated in FIG. 5B, some through holes 52 of one of the ring flanges have oblong sections and other through holes 52′ of the same ring flange have circular sections. For preference, the through holes 52 of oblong section are distributed evenly about the circumference of the ring flange. The same is true of the through holes 52′ of circular section. According to one preferred embodiment, at least half of the through holes of a ring flange have oblong sections.

This configuration makes it possible to limit the spread of circumferential deformation from one duct to the other over at least part of the circumference. These circumferential deformations are generally markedly smaller than the radial deformations (perpendicular to the longitudinal direction) or than the axial deformations (parallel to the longitudinal direction) and can be absorbed thanks to the ability that the shanks 56 have to move in the through holes of oblong section. A circumferential deformation can be limited to part of the circumference. Thus, when a radial deformation occurs at a localized point on the circumference, circumferential deformations tend to appear on each side of the localized radial deformation, the two circumferential deformations having opposite directions of rotation, oriented towards the localized radial deformation. As a variant, the through holes in the two ring flanges have oblong sections. This configuration makes it possible to increase the amplitude of the relative pivoting movement of the two ducts relative to one another.

Combining the oblong shape of section with sections that widen in the direction of the junction plane makes it possible to limit the risks of circumferential deformation spreading and of the shanks of the connecting elements shearing.

The oblong sections have a central portion with, at each end 62, a portion that forms a semicircle.

According to one embodiment, the central portion is delimited by two straight edges 64 perpendicular to the radial direction, the spacing between the two straight edges corresponding to the smallest dimension of the oblong shape.

According to another embodiment, the central portion is delimited by two circular-arc-shaped edges centered with respect to the axis of the ducts, the spacing between the two circular-arc-shaped edges corresponding to the smallest dimension of the oblong shape.

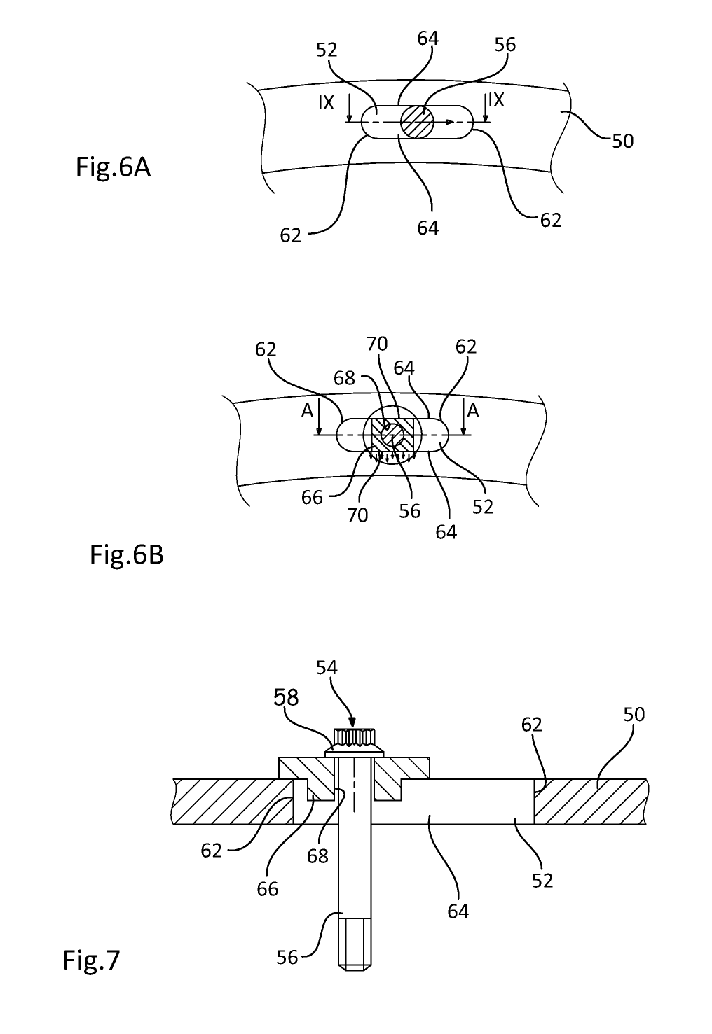

According to a first variant illustrated in FIG. 6A, the shank 56 has a diameter substantially equal to the smallest dimension of the smallest section. In this case, the contact zone for contact between the shank and the edge of the through hole is reduced, and this has a tendency to increase the risks of peening.

In order to overcome this disadvantage, according to another variant illustrated in FIGS. 6B and 7, the smallest dimension of the smallest section is greater than the diameter of the shank 56. In addition, the connecting element 54 comprises an element 66 intercalated between the shank 56 and the edges 64 of the central portion. In order to reduce contact pressures and spread them over a larger area, the intercalated element 66 has a through hole 68 the diameter of which is preferably equal, to within the clearance, to that of the shank 56, and two edge faces 70 facing one another, the shapes of which are identical to the edges 64 of the oblong shape so as to allow the intercalated element 66 to slide without clearance (or with minimal clearance) in the central portion of the oblong shape of the sections.

According to a first embodiment, the intercalated element 66 is separate from the lands 58 and 60 of the connecting element 54. By way of example, the intercalated element 66 takes the form of a sleeve of square or rectangular outline.

According to a second embodiment illustrated in FIG. 7, the intercalated element 66 is incorporated into one of the lands 58. Thus, a nut or a washer of the connecting element comprises a square or rectangular boss which performs the intercalated-element 66 function.

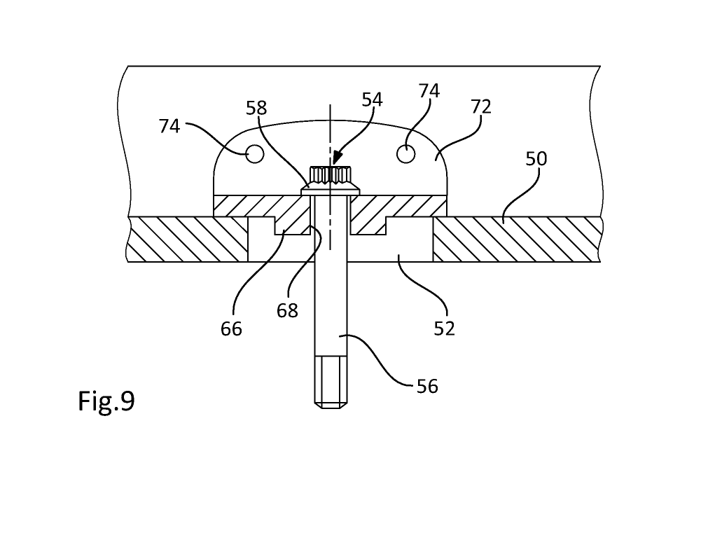

According to a variant illustrated in FIG. 9, the intercalated element 66 comprises a through hole 68 the diameter of which is preferably equal, to within the clearance, to that of the shank 56. According to this variant, the intercalated element 66 is connected to the duct 40 of the air intake. For that purpose, the intercalated element 66 comprises a tab 72 pressed firmly against the duct 40 or the cylindrical portion of a flange that forms the annular ring flange 50, the said tab being connected to the duct 40 or to the cylindrical portion using at least one connecting element 74 such as a rivet for example.

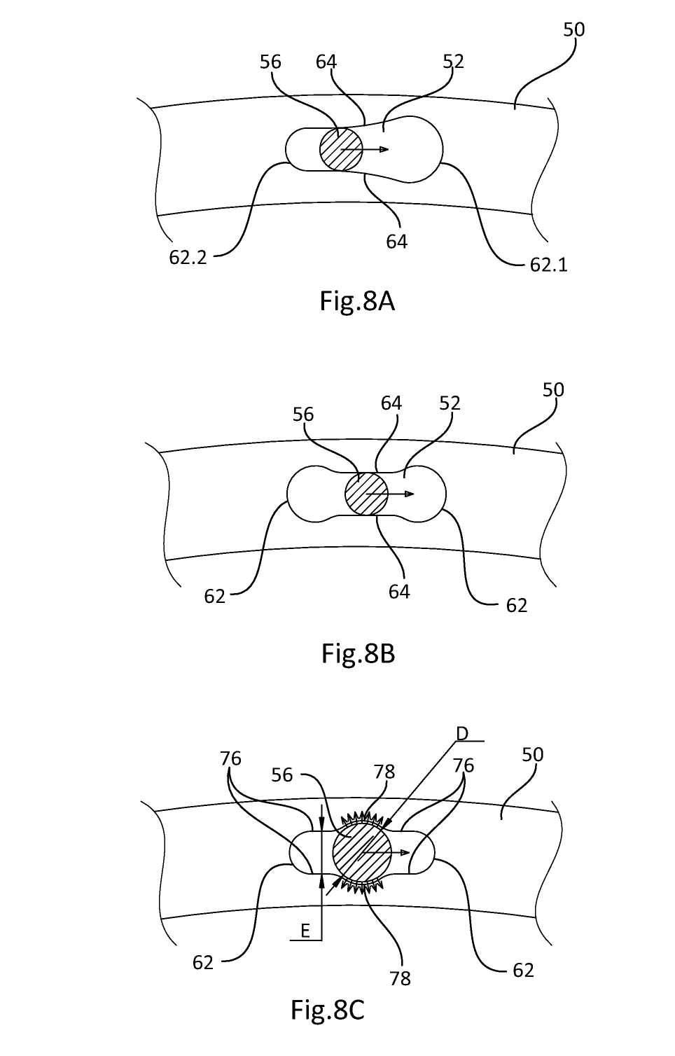

As illustrated in FIGS. 8A to 8C, there are other conceivable variants for the oblong section.

According to a variant illustrated in FIG. 8A, the separation between the two edges 64 is non-constant. Thus, one end 62.1 may have a greater radius of curvature than the other end 62.2. In this variant, the central portion has a widening shape. Depending on the circumstances, each edge 64 may be straight or non-straight or may comprise at least one straight portion and/or at least one curved portion.

According to another variant illustrated in FIG. 8B, the ends 62 are identical and wider than the central portion. In such an instance, the ends 62 have a circular-arc shape the diameter of which is greater than the distance separating the two edges 64.

According to another variant illustrated in FIG. 8C, the central portion comprises edges 64 with straight portions 76 arranged on either side of a circular-arc-shaped portion 78. The circular-arc-shaped portions 78 have a diameter equal, to within the clearance, to the diameter of the shank 56, whereas the distance E separating the edges 64 outside of the circular-arc-shaped portions 78 is less than the diameter of the shank 56. This configuration allows some of the energy to be absorbed in the event of rotation thanks to the deformation of the edges 64 by the shank 56.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. An aircraft nacelle comprising:
two ducts, a first duct secured to an air intake and a second duct secured to a powerplant,
the ducts being arranged coaxially in a longitudinal direction, in contact with one another at a junction plane and joined together by a connection which comprises a plurality of through holes oriented in the longitudinal direction and connecting elements housed in the through holes,
each connecting element comprising a shank with, at each end, lands allowing the ducts to be joined together,
at least one through hole of at least one of the two ducts having an oblong section with the largest dimension oriented to allow relative rotation of the two ducts about an axis in the longitudinal direction.

2. The aircraft nacelle according to claim 1, wherein the oblong sections have a central portion delimited by two straight edges perpendicular to a radial direction.

3. The aircraft nacelle according to claim 1, wherein the oblong sections have a central portion delimited by two circular-arc-shaped edges which are centered with respect to the axis of the ducts.

4. The aircraft nacelle according to claim 2, wherein the oblong sections have circular-arc-shaped ends, a diameter of which is greater than a distance separating the two edges.

5. The aircraft nacelle according to claim 1, wherein the oblong sections have a central portion delimited by two edges of non-constant separation.

6. The aircraft nacelle according to claim 1, wherein the shank has a diameter substantially equal to a smallest dimension of a smallest section.

7. The aircraft nacelle according to claim 1, wherein a smallest dimension of a smallest section is greater than a diameter of the shank.

8. The aircraft nacelle according to claim 7, wherein the connecting element comprises an element intercalated between the shank and edges of the central portion, the element having two edge faces facing one another and the shapes of which are identical to the edges of the oblong shape.

9. The aircraft nacelle according to claim 8, wherein the element is separate from the lands of the connecting element.

10. The aircraft nacelle according to claim 8, wherein the element is incorporated into one of the lands of the connecting element.

11. The aircraft nacelle according to claim 1, wherein the oblong sections each have a central portion with edges which comprise circular-arc-shaped portions of a diameter equal, to within the clearance, to the diameter of the shank, the distance separating the edges outside of the circular-arc-shaped portions being less than the diameter of the shank.

12. The aircraft nacelle according to claim 1, wherein one of the ducts comprises through holes with oblong sections and through holes with circular sections.

13. The aircraft nacelle according to claim 12, wherein at least half of the through holes of a ring flange have oblong sections.

14. The aircraft nacelle according to claim 1, wherein the through holes have sections which widen in the direction of the junction plane.
